(19) United States
(12) Patent Application Publication
(10) Pub. No.: US 2015/0138351 A1
(43) Pub. Date: May 21, 2015

(54) DEVICE AND METHOD FOR MEASURING THE DIMENSIONS OF ELEMENTS OF A RAILWAY TRACK

(71) Applicant: ROV DEVELOPPEMENT, La Ciotat (FR)

(72) Inventor: Edmond Briand, La Ciotat (FR)

(21) Appl. No.: 14/400,607

(22) PCT Filed: Jun. 26, 2013
(86) PCT No.: PCT/FR2013/051483

§ 371 Date: Nov. 12, 2014

(30) Foreign Application Priority Data
Jun. 28, 2012 (FR) 1256179

(51) Int. Cl. B60M 1/28; E01B 35/00; G01C 15/00

(52) U.S. Cl. CPC B60M 1/28; G01C 15/002; E01B 35/00
USPC 348/139

(57) ABSTRACT

The invention relates to a device for measuring at least one dimension of at least one element constituting a railway track, comprising a housing having a camera and a laser rangefinder pointing in the same direction as the camera, said housing being provided with a guide suitable for being positioned against a known reference point relative to said element of which a dimension is to be measured, as well as to a device for receiving, transmitting, computing, storing, and displaying information from the camera and the laser rangefinder and for remotely controlling these latter.

### CROSS REFERENCE TO RELATED APPLICATIONS

The present application is a U.S. National Phase Application pursuant to 35 U.S.C. §371 of International Application No. PCT/FR2013/051483 filed Jun. 26, 2013, which claims priority to French Patent Application No. 1256179 filed Jun. 28, 2012. The entire disclosure contents of these applications are herewith incorporated by reference into the present application.

The purpose of this invention is a device and a method for measuring dimensions of elements of a railway track.

The electric power is supplied to trains equipped with electric motors by means of an overhead catenary system suspended above the track on which these trains run, between the support posts or arched catenary supports or other carrying structures spaced along the track. A typical catenary system simply designated below as a catenary, includes a contact wire suspended on suspension elements of a carrying cable, which elements or suspension structure, consisting of braces and connection arms, are secured to the support posts. The contact wire is maintained at a high electric potential and supplies the electric power to pantographs mounted on the roof of the trains.

The carrying cable forms as a result of the gravity pull, a curve in the vertical plane, which approaches a parabola portion, between the support posts, but the contact wire is kept in parallel with the track by varying the length of the lines that support and connect the contact wire suspended to the carrying cable.

The position of the catenary above the track must be carefully checked and preserved in a predetermined position to ensure continuous contact between the pantograph and the contact wire and to guarantee, the supply of electric power to the train without unscheduled interruption.

Therefore, during construction, and then during the use of the railway track, that will be considered in this invention as designating not only the rails specifically but also all of the equipment that enables the trains to run on them, such as the catenary, its supporting posts or arched frames, its carrying elements, braces and arms, and all other means that are involved in maintaining it in position, it is necessary to know well and check the position and the dimension of all this equipment as well as their distance, one with respect to the other.

If during construction of the railway tracks, the companies have tools available that permit them to comply optimally with these positions and dimensions and especially since access to the work sites is then open, the problem is more complex to check during operation, especially for those involving overhead equipment, which are the most likely to modify their position over time, and moreover, without disturbing too much the trains from running.

Until now, these measurements are made by hand with simple “multimeters” (double, triple, . . . ) and with the help of basket or ladders, which for safety reasons force to cut the electric power supply of the contact wire and consequently, to stop the trains; it mobilizes rather large teams of participants and it takes time, and it does not allow for great accuracy nor reliable recordings of these measurements due to risks of errors while taking the measurements and then during transcribing the measurements on a support and finally during recopying.

The problem at hand is consequently being able to making these measurements, such as taking the measurements of the supporting posts profiles, the distance between them especially those that are face to face, the distance of the catenaries in the sectioning points, the distance between the axes of the contact wire tension device and of the carrying cable, the heights and lengths of the anti-swaying brackets, etc. . . . with as little disturbance possible for train traffic, rapidly, with ease of implementation, in all safety and with a good accuracy and reliability of recording.

A solution to this problem is a measuring device with at least one dimension of at least one element constituting a railway track and which device includes at least a housing carrying a camera and a laser range finder pointing in the same direction as the camera, and a device for receiving, transmitting, computing, storing, displaying and control from a distance of this camera and of this laser range finder, with this housing being equipped with a guide capable of being positioned against a known reference point with respect to said element for which at least one dimension is to be measured.

For a preferred method of embodiment, this housing is mounted at the distal end of a pole, and positioning of the guide is done by handling the proximal end of the pole.

Another solution to the problem is a measuring method of at least one dimension of at least one element constituting a railway track so that:
A housing is positioned, comprising at least one camera module and one laser range finder module pointing in the same direction, against a first known reference point with respect to the part of said element for which a dimension is to be measured,
One points the camera towards this target part of said element and one views the image of this target part on the display and control screen of a device for receiving, transmitting, computing, storing, displaying and piloting from a distance of the camera and of the laser range finder,
One displays on this same image the laser point of the range finder and one moves the range finder module until this laser point coincides with the second predefined measuring reference point situated on the target part,
One takes down the distance measurement made with the range finder, between the two reference points; this distance represents a first dimension searched for said element,
Knowing the amplitude of the zoom of the camera and this distance between said reference points, one deduces at least a second dimension of this element by measuring this dimension on a photo taken by the camera or directly on the image captured by the camera and shown on the display and control screen.

The result is a new device and method for measuring dimensions of elements of a railway track, as described more accurately in the application examples below and which permits making these remote measurements without the direct contact of man on these elements, without having to cut the power and while intervening in total safe, rapid and easy way, with little disturbance of the train traffic, while achieving good accuracy and excellent reliability of the measurement recordings thanks to an automatic transfer of the data taken down to the memory of a micro-computer and consequently, without the possibility of human error in recopying.

Such a device and method does not have the inconveniences of the present systems and methods described above and meets all of the objectives of the problem posed.

The advantages pointed out above of this new device and method for remote measuring are shown by the interest, and the description below and the figures attached give two application and implementation examples.

Other modes and methods of embodiment are possible however within the framework of the scope of this invention.

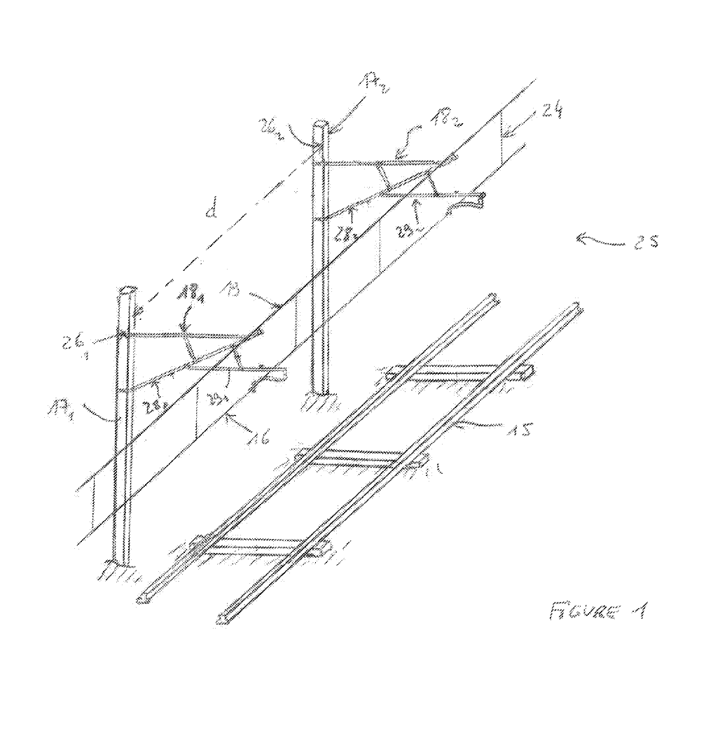

FIG. 1 is a perspective diagram of a typical railway track 25, represented here with a single set of rails 15 above which one finds a catenary assembly secured onto lateral supporting posts 17 and represented here according to a typical example of embodiment. The arched structure of this catenary comprises braces 28 that form a main arm, a second arm 18 forming a brace that supports the arm 28, and a third arm 29 that forms an anti-swaying device and is connected to brace 28 in an adjustable fashion; these three arms can be connected two by two using spacers; this anti-swaying device 29 ends in a steady arm that supports contact wire 16, while the main arm that forms brace 28 supports carrying cable 19 connected to contact wire 16 between two posts 17 by lines 24 to hold contact wire 16 parallel to the track. These suspension elements representing the arched structure of the catenary and the catenary itself, are not shown on the other figures while needless to say, they are present for implementing the device and method of the invention.

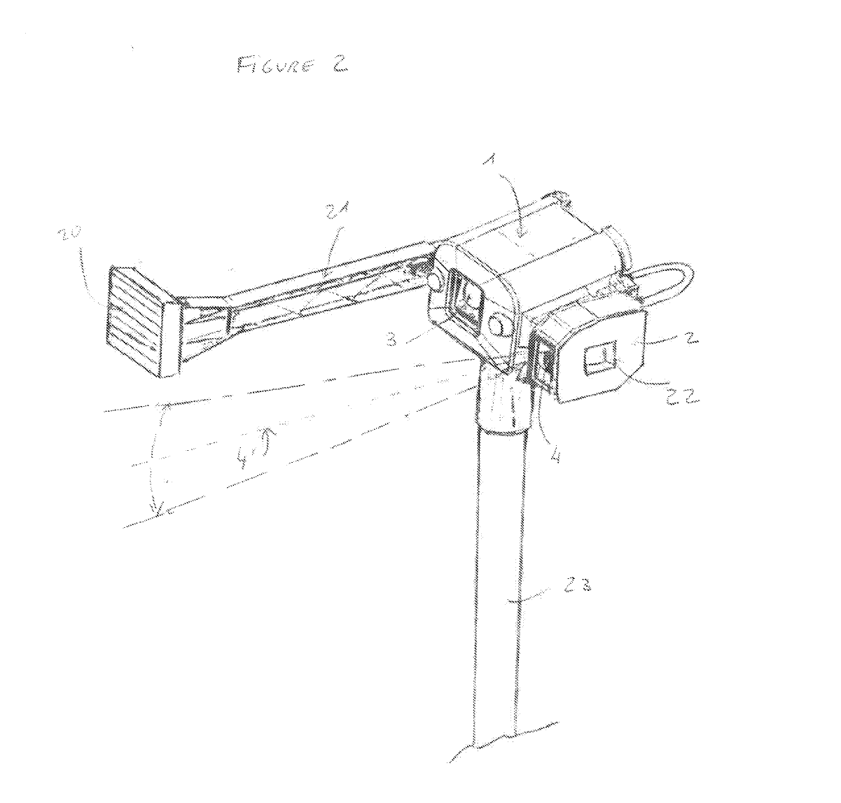

FIG. 2 is a perspective view of a device according to the invention mounted on a partially shown handling pole capable to measure for instance the distance “d” between two lateral carrying posts.

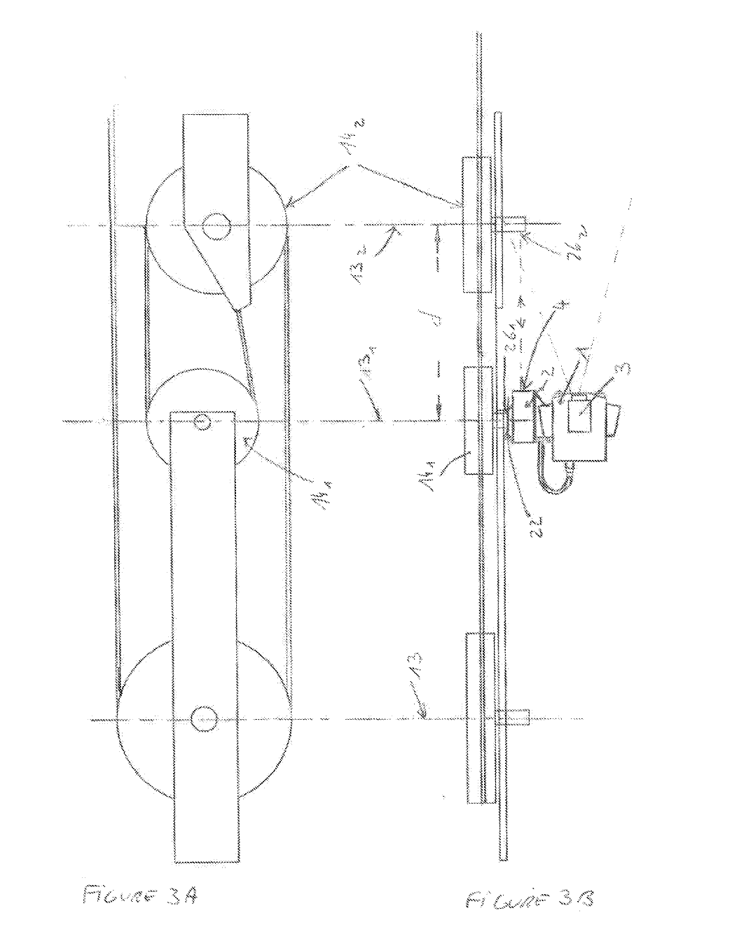

FIGS. 3 are side and top views of a tensioning device of a carrying cable or of a contact wire with a device according to the invention placed against a roller pin and capable of measuring the distance “d” with another pin.

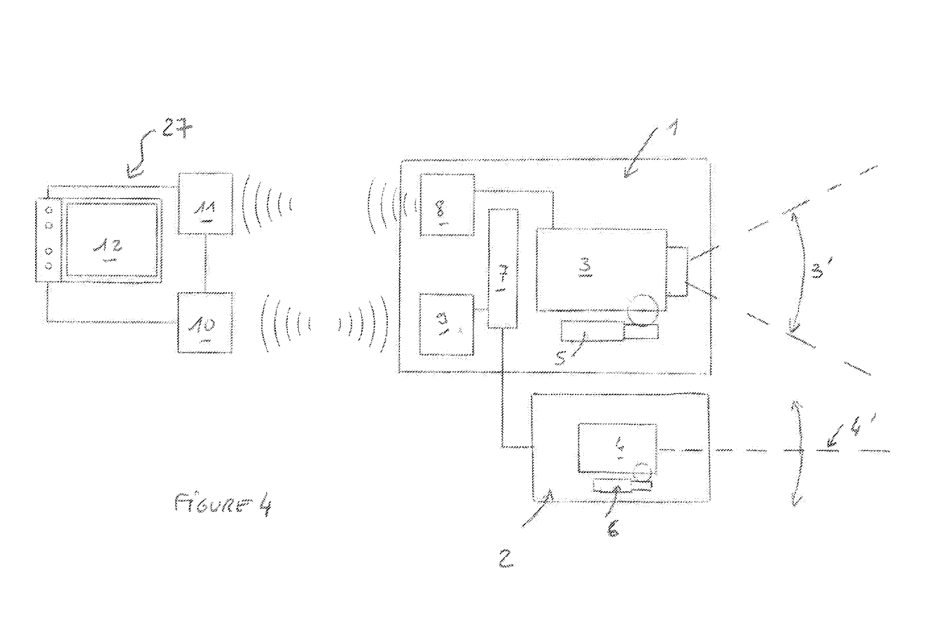

FIG. 4 is an example of the installation and connection diagram of the various equipment items representing a device according to the invention.

The measuring device comprises on the one hand at least a housing 1 carrying a camera 3 and a laser range finder 4 pointed in the same direction as camera 3 and on the other hand a device for receiving, transmitting, computing, displaying and controlling from a distance 27 of camera 3 and of laser range finder 4, and which can be made up of a portable computer with its screen 12 and two transmitters-receivers 10, 11; this range finder 4 can be enclosed in a second housing 2 secured on the side against that 1 of the camera as shown on the figures but all of this equipment can also be enclosed in a single housing.

Transmission between housing or housings 1, 2 and the device for receiving, transmitting, computing, displaying and controlling 27 is preferably a wireless transmission of a known type.

The housing or housings 1, 2 are installed at the distal end of a pole 23 of the desired height and which can be telescopic and for which the length is consequently adjustable, to reach any predefined point located at said height, and of which the other proximal end can be carried by an operator.

This housing 1 or at least one of housings 1,2 is equipped with a guide, 20, 22 that can be positioned against a known reference point 26 relative to said element for which a dimension is to be measured, and positioning this guide 20, 22 is done by handling the proximal end of pole 23.

As shown on FIG. 2, this positioning guide of the device against reference point 26 can be a stop 20 mount on an arm 21 secured on the side of one or of housing 1 and for which the distal end is located in the field of vision 3′ of camera 3: consequently, by checking screen 12 showing the image taken by the camera, the operator can situate stop 20 at the desired location such as against a reference point on a supporting post 17: if one wants to know distance “d” of this post with another supporting post according to the method described below, it suffices to correct the distance measured by the range finder to take into account the length of arm 21 relative to the position of range finder 4; this correction is achieved automatically by the computation and displaying device such as a microcomputer 12.

For other applications, as on FIGS. 3, the positioning guide of the device against reference point 26 is an interface 22 located on one side of the housing 1 or of housing 2 as shown on FIG. 2, and capable of cooperating a specific form of reference point 26 with respect to which one wants to measure a dimension of said element: this reference point can be end 26ₖ, a pin 13₁ of a pulley or a roller 14₁, of a cable or wire tensioning device and the specific form of the interface that forms the positioning guide is then a hollow print 22 capable of working with this end.

Indeed, to obtain a sufficient rigidity through the contact action of the pantograph head of the trains, the contact wire and the carrying cable are tightened mechanically: for that, a tensioning device is used for which the mechanical tension must be constant no matter the ambient temperature (defined within a temperature range). Then, one should be able to measure distance “d” between the two pins of the pulleys or rollers of the tensioning device: this dimension permits checking the setting of the tension of the line at a given temperature.

To properly direct the laser range finder 4 towards the target, the latter is installed in a mobile fashion, thanks to an orientation motor 6 around at least one horizontal pin and its sight 4′ thus permits covering a vertical field in the field of vision of the camera.

Preferably, the laser range finder 4 and the camera 3 are both mobile; camera 3 thanks to an orientation motor 5; the movements of the laser range finder 4 can be interlocked to those of camera 3 at least during the approach phase; control over the laser range finder 4 orientation can then take place manually to sharpen its sight or aim towards the second desired reference point.

Indeed, the measuring method according to the invention of at least one dimension of at least one element constituting a railway track 25 such as the distance between two tension roller pins 14, or the diameter of one of these rollers, or the separation distance between two supporting posts 17 or taking the dimensions of their profiles, the height and the lengths of braces 28 or of anti-swaying arms 29, is such that:
One positions one housing 1, comprising at least one camera module 3 and one laser range finder module 4 pointing in the same direction, against a first known reference point 26₁ relative to the part of said element for which a measurement is to be made,
One directs camera 3 towards this target part of this element and one views the image of this target part on display and control screen 12 of a device 27 for receiving, transmitting, computing, displaying and controlling from a distance of camera 3 and of laser range finder 4,
One displays on this same image the laser point of range finder 4 and one moves the module of the range finder until this laser point coincides with the second measurement reference point 26₂ that is predefined and located on the target part and for that one can use the zoom of camera 3 to position the laser view point as best as possible,
One takes down the distance measurement made by range finder 4 between the two 26₁ and 26₂ reference points; this distance represents a first desired dimension of said element.

Knowing the amplitude of the camera 3 zoom and the distance between said reference points 26, one can then deduce at least a second dimension of this element by direct measurement of the image of this dimension captured and taken by camera 3, and either printed according to a predetermined photo format and a known scale, or directly as shown on the display and control screen 12 of device 27 for receiving, transmitting, computing, displaying and controlling from a distance: as such, one can measure from a distance and know the dimensions of a given element such as the diameter of a cable or wire, a pin, a pulley, etc.—with a sufficiently good accuracy such as 0.2% of the distance from the device to the element considered, which requires however that the device is positioned close enough to that element.

The accuracy of the distance measurement made with range finder 4 is better of course, namely 2 mm for a distance of 80 meters.

According to the diagram of FIG. 4, housing 1 includes besides camera 3 and its orientation motor 5, a video and control transmitter 8 of camera 3, and a transceiver for controlling range finder 4 through a built-in electronics 7, while housing 2 includes laser module 4 and its orientation motor 6 but as said before, all these elements could be located in a single housing or even been distributed over two housings but differently.

This or these housings 1, 2 communicate at the distance by the transmitters-receivers 8, 9 with corresponding transmitters-receivers 10, 11 of device 27 for receiving, transmitting, computing, displaying and controlling.

1. A device for measuring at least one dimension of at least one element that forms a railway track comprising at least one housing carrying a camera and one laser range finder pointing in the same direction as the camera, the housing being equipped with a guide capable of positioning against a known reference point relative to said element for which a dimension is to be measured, and the measuring device includes a device for receiving, transmitting, computing, storing, displaying and controlling from a distance the camera and the laser range finder.

2. The device for measuring according to claim 1 wherein said housing is installed at the distal end of a pole and the position of the guide is achieved by handling the proximal end of the pole.

3. The device for measuring according to claim 1 wherein the laser range finder is mounted in a mobile fashion around at least a horizontal pin.

4. The device for measuring according to claim 3 wherein the laser range finder and the camera are both mobile and the movements of the laser range finder are interlocked to those of the camera.

5. The device according to claim 1 wherein the transmission between the housing and the device for receiving, transmitting, displaying and control works by wireless transmission.

6. The device according to claim 1 wherein the positioning guide of the device against the reference point is a stop mounted on an arm secured to the housing and located in the field of the camera.

7. The device according to any of claim 1 wherein the positioning guide of the device against the reference point is an interface located on the housing and capable of working with a specific form of the reference point for which a dimension of said element is to be measured.

8. A method of measuring at least one dimension of at least one element forming a railway track, the method comprising:
positioning a housing, comprising at least one camera module and one laser range finder module pointing in the same direction, against a first known point of reference with respect to the part of said element for which a dimension is to be measured;
directing the camera to this target part of this element, and viewing the image of this target part on a display and control screen of a device for receiving, transmitting, computing, storing, displaying and controlling from a distance the camera and the laser range finder;
viewing on this same image a range find laser point and moving the laser range finder module until the laser point coincides with a second reference point of predefined measurement and situated on the target part; and
taking down the distance measurement, done with the laser range finder, between the two reference points this distance represents a first dimension of said element.

9. The method according to claim 8 wherein a zoom of the camera is used to position the laser viewing point as well as possible.

10. The method according to claim 8 further comprising knowing the amplitude of the camera zoom and the distance between said reference points, deducing at least a second dimension of this element by direct measurement of the image of this dimension captured and taken by the camera.
